(19) United States
(12) Patent Application Publication
(10) Pub. No.: US 2002/0196755 A1
(43) Pub. Date: Dec. 26, 2002

(54) Portable communication terminal and wireless communication system therefor

(76) Inventors: Hiroyuki Hidaka, Yokohama-shi (JP); Nobuhiko Ikeda, Yokohama-shi (JP)

Correspondence Address: Donna L. Angotti, Schulte Roth & Zabel LLP, 919 Third Avenue, New York, NY, 10022, US

(21) Appl. No.: 10/144,093

(22) Filed: May 10, 2002

(30) Foreign Application Priority Data
May 11, 2001 (JP) 2001-141975
Sep. 18, 2001 (JP) 2001-283626

(51) Int. Cl. H04B 7/216

(52) U.S. Cl. 370/335; 370/342

(57) ABSTRACT

A portable communication terminal provides multiple transceivers allowing reception and transmission of signals in accordance with multiple wireless communication systems (e.g., cdma2000 1x-EV DO and cdma2000 1x systems). When the predicted future data communication speed becomes lower than the prescribed threshold, the portable communication terminal automatically switches from one system to another. In addition, the portable communication terminal monitors amounts of data that are received by the preset time period (Td) each. That is, if the reception data rate is continuously reduced lower than the prescribed threshold for the prescribed time period (T), the portable communication terminal automatically switches from one system to another. Thus, it is possible to normally provide the user with a good data communication service, regardless of data communication environments.

### BACKGROUND OF THE INVENTION

1. Field of the Invention

This invention relates to portable communication terminals that perform data communications in accordance with prescribed wireless communication systems such as code division multiple access (CDMA) systems.

2. Description of the Related Art

Recently, ‘cdma2000 1x-EV DO’ has been developed as the next-generation high-speed wireless communication system. The cdma2000 1x-EV DO system (where ‘EV’ denotes ‘Evolution’, and ‘DO’ denotes ‘Data Only’) is designed to standardize the HDR (High Data Rate) system, which is an expansion of the cdma2000 1x system developed by the Qualcomm company. Specifically, it has been standardized as Std. T-64 IS-2000 C.S.0024 “cdma2000 High Rate Packet Data Air Interface Specification” by the ARIB (or American Radio Industry Bureau). At present, the KDDI Co. Ltd. in Japan provides services based on the cdmaOne system, which is referred to as ‘ARIB T-53’ in Japan and is also referred to as ‘EIA/TIA/IS-95’ in North America and Korea (where ‘EIA’ stands for ‘Electronic Industry Association’, and ‘TIA’ stands for ‘Telecommunication Industry Association’). The cdma2000 1x system is an expansion of the cdmaOne system to suit the third generation network (3G). Compared to the cdma2000 1x system, the cdma2000 1x-EV DO system is further developed to improve communication speeds, in particular, with respect to data communications.

The cdma2000 1x-EV DO system is designed to change over data modulation methods in data communications between base stations and portable communication terminals (e.g., cellular phones) in response to the information for notifying conditions of reception at the portable communication terminals. Specifically, it allows the portable communication terminal to use a high-speed communication rate having a relatively low level of error resistance when the portable communication terminal has good reception conditions and allows the portable communication terminal to use a low-speed communication rate having a relatively high level of error resistance when the portable communication terminal has bad reception conditions.

In the downstream (that is, in the communicating direction from the base station to the portable communication terminal), the cdma2000 1x-EV DO system employs TDMA (Time-Division Multiple Access, or Time-Division Multiplexing) that allows multiple communications among portable communication terminals with changeovers therebetween with respect to time, wherein only one portable communication terminal is allowed to perform communication in each time unit of 1/600 second. This allows data communications by the portable communication terminals to individually operate with maximal power. Thus, it is possible to perform data communications at a high communication speed among the portable communication terminals.

In the aforementioned cdma2000 1x-EV DO system, the portable communication terminals must be able to deal with their receiving conditions that vary depending on location. That is, this system ensures high-speed communications maximally at 2.4 Mbps in a good radio field that is defined as the electric field strength in reception and the carrier-to-interference ratio, for example. However, it has a drawback in that the communication speed is reduced to about 10 kbps under bad reception conditions.

Therefore, the user of the portable communication terminal can easily complete downloading of a relatively large amount of data in a short period of time without experiencing stress in data communication at a location having good receiving conditions. In contrast, when the user of the portable communication terminal starts downloading a relatively large amount of data at a location having bad receiving conditions and where a relatively low data communication speed is provided for the downstream direction, a relatively long time will be required to complete the downloading of all the data. In short, the aforementioned cdma2000 1x-EV DO system may not always guarantee optimal environments in data communication services for users. In addition, it has a drawback in that communication fees must be significantly increased as communication time becomes longer.

In order to enjoy a comprehensive service that allows the user to download motion picture data and music data while simultaneously reproducing these data (in other words, ‘streaming reproduction’ of motion picture and music), the portable communication terminals require higher downstream data communication speeds that are normally higher than the prescribed value. However, if it is hard to perform data communications at the ‘required’ downstream data communication speeds, the users of the portable communication terminals cannot obtain the prescribed service quality because of problems due to the reduction of the picture and sound quality, intermittent stoppage of motion pictures, and intermittent breaks in the sound, for example.

Even though the present portable communication terminal is in a location with good radio field conditions, if there exist other portable communication terminals whose radio field conditions are better in the same service area, the prescribed base station first allocates data communication channels to the other portable communication terminals prior to doing so for the present portable communication terminal. In this situation, the present portable communication terminal must deal with a relatively low data rate in the data communication with the prescribed base station because its communication capacity is greatly occupied by the other portable communication terminals. That is, even though the user visually recognizes on the screen that the present portable communication terminal is in a location with good radio field conditions, the data communication may proceed at an unexpectedly slow rate, causing the user to experience doubt or distrust in data communication services.

### SUMMARY OF THE INVENTION

It is an object of the invention to provide a portable communication terminal and a wireless communication system therefore in which data communications can be stabilized normally, regardless of communication environments.

Specifically, the portable communication terminal provides transceivers that operate based on plural wireless communication systems respectively, wherein the optimal wireless communication system is automatically selected in response to the expected communication speed. That is, the portable communication terminal provides transceivers that operate based on the cdma2000 1x-EV DO system, which ensures high-speed data communications, and the cdma2000 1x system respectively. When the data communication speed becomes lower than the prescribed threshold during the data communication based on the cdma2000 1x-EV DO, the portable communication terminal automatically switches to the cdma2000 1x system so as to secure a sufficiently high data communication speed at any time.

More specifically, the portable communication terminal predicts future data communication speeds based on pilot signals transmitted thereto from the prescribed base station for the prescribed wireless communication system, i.e., the cdma2000 1x-EV DO system that is given a first priority in reception and transmission of signals. When the predicted future data communication speed becomes less than the prescribed threshold, the portable communication terminal automatically switches to the other wireless communication system, i.e., the cdma2000 1x system, and waits for the restoration of the data communication speed. At this time, the portable communication terminal issues and sends a wireless communication system changeover instruction to the prescribed base station, so that the exchange (or local switch) reads from the base station table the information regarding the other base station, which is sent to the portable communication terminal via the prescribed base station. In addition, the exchange temporarily stops the data communication that was performed by the portable communication terminal via the prescribed base station. Upon receipt of the information, the portable communication terminal proceeds to establish a new communication line with the other base station. After the completion of the establishment of the communication line, the exchange restarts the data communication with the portable communication terminal via the other base station.

Thereafter, when the predicted data communication speed becomes equal to or greater than the prescribed threshold, the portable communication terminal automatically switches to the prescribed wireless communication system, so that the data communication is performed via the prescribed base station again.

In addition, the portable communication terminal monitors amounts of data that were received during the data communication based on the cdma2000 1x-EV DO system. When the amounts of data continuously fall below the prescribed threshold for the prescribed time period, the portable communication terminal automatically switches to the cdma2000 1x system so as to secure comfortable data communication in a stable manner even though the prescribed base station does not provide the high-speed data communication service because its data communication capacity is greatly occupied by other terminals or devices.

That is, the portable communication terminal automatically changes over the wireless communication system thereof in response to amounts of data that are measured in the first time period even though it has good radio field conditions. That is, a reception data rate is measured in a first time period and is compared with the prescribed threshold. If the reception data rate is not greater than the prescribed threshold, the timer is started to count a second time period. Therefore, the portable communication terminal automatically switches from the prescribed wireless communication system (e.g., cdma2000 1x-EV DO system) to the other wireless communication system (e.g., cdma2000 1x system) if the reception data rate is continuously reduced for the second time period or more. If the reception data rate is greater than the prescribed threshold, the portable communication terminal continues its data communication in accordance with the prescribed wireless communication system.

### BRIEF DESCRIPTION OF THE DRAWINGS

These and other objects, aspects, and embodiments of the present invention will be described in more detail with reference to the following drawings, in which:

FIG. 1 is a block diagram showing the configuration of a portable communication terminal in accordance with a first embodiment of the invention;

FIG. 2 is a flowchart showing the overall operation of the portable communication terminal in the data communication;

FIG. 3 shows a network architecture that enables the portable communication terminal to perform data communications with multiple base stations in accordance with different wireless communication systems respectively;

FIG. 4 is a flowchart showing a wireless communication system changeover determination process that is performed by a portable communication terminal in accordance with a second embodiment of the invention;

FIG. 5 is a graph showing variations of the reception data rate D1 over time; and

FIG. 6 is a graph showing variations of the reception data rate D1 over time.

### DESCRIPTION OF THE PREFERRED EMBODIMENTS

This invention will be described in further detail by way of examples with reference to the accompanying drawings.

First Embodiment

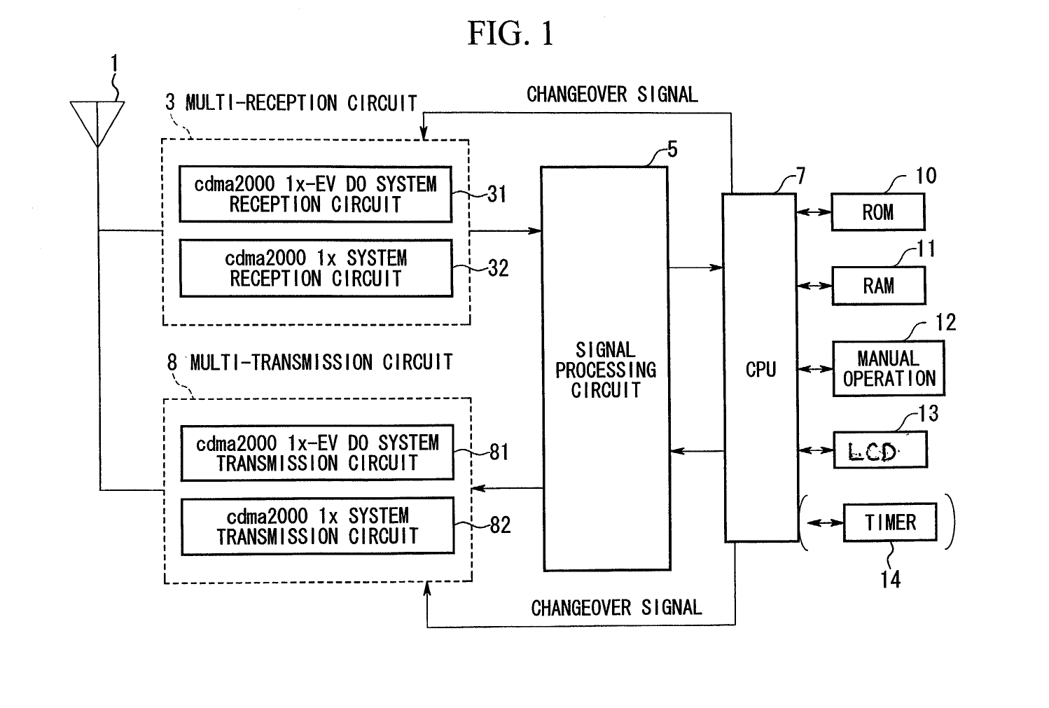

FIG. 1 shows the configuration of a portable communication terminal in accordance with a first embodiment of the invention. The portable communication terminal of FIG. 1 comprises antenna 1, multi-reception circuit 3, signal processing circuit 5, CPU 7, multi-transmission circuit 8, ROM 10 for storing various programs, RAM 11, manual operation section 12 providing numeric keypads, a keyboard, and the like, and liquid crystal display (LCD) 13. Both multi-reception circuit 3 and multi-transmission circuit 8 are designed to suit multiple wireless communication systems. Hence, multi-reception circuit 3 contains multiple reception circuits therein, and multi-transmission circuit 8 contains multiple transmission circuits therein. Signal processing circuit 5 performs prescribed digital processing on signals output from multi-reception circuit 3. CPU 7 performs prescribed controls on various parts of the portable communication terminal.

Specifically, multi-reception circuit 3 contains reception circuit 31 for the cdma2000 1x-EV DO system and reception circuit 32 for the cdma2000 1x system. Hence, multi-reception circuit 3 changes over these circuits in response to changeover signals supplied thereto from CPU 7, so that the optimal reception circuit is automatically selected to receive data transmitted thereto from the prescribed base station (not shown).

Similarly, multi-transmission circuit 8 contains transmission circuit 81 for the cdma2000 1x-EV DO system and transmission circuit 82 for the cdma2000 1x system. Multi-transmission circuit 8 changes over these circuits in response to changeover signals supplied thereto from CPU 7, so that the optimal transmission circuit is automatically selected to transmit data towards the base station.

As described above, the portable communication terminal of the present embodiment is characterized by providing multiple pairs of reception circuits and transmission circuits to suit different wireless communication systems respectively. Herein, the portable communication terminal automatically changes over these circuits in response to speeds of data communications that are performed with base stations. Thus, it is possible to normally stabilize data communications, regardless of data communication environments.

ROM 10 stores in advance various programs that are executed by CPU 7. By loading and executing these programs stored in ROM 10, CPU 7 performs various types of processing. RAM 11 stores data that are created during the processing executed by CPU 7. In order to install wireless modem functions in the portable communication terminal, it is possible to additionally provide external interfaces for personal computers, such as serial ports, parallel ports, USB (Universal Serial Bus) ports, Bluetooth communicators, infrared communicators, 10BaseT LAN interfaces (based on the Ethernet LAN standard), and the like.

Operation of the Portable Communication Terminal

Next, the overall operation of the portable communication terminal will be described with reference to FIGS. 1 to 3.

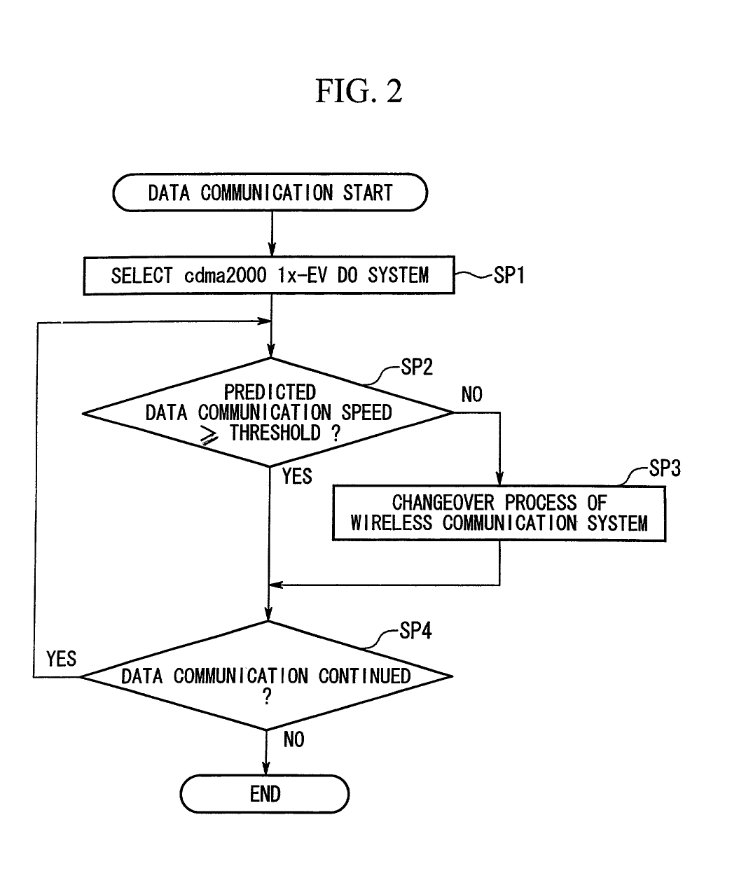

First, in order to download data from the prescribed provider or server, the user operates keys of manual operation section 12 to set download information with respect to the download destination address and download data, which are required to establish data communication with the destination; then, the user inputs a download request to the portable communication terminal. The download request that is entered using manual operation section 12 is forwarded to CPU 7, which in turn outputs changeover signals (or select signals) to multi-reception circuit 3 and multi-transmission circuit 8 respectively, so that reception circuit 31 and transmission circuit 81 are selected to suit the cdma2000 1x-EV DO system in step SP1 shown in FIG. 2.

That is, multi-reception circuit 3 and multi-transmission circuit 8 initially select reception circuit 31 and transmission circuit 81 based on the cdma2000 1x-EV DO system.

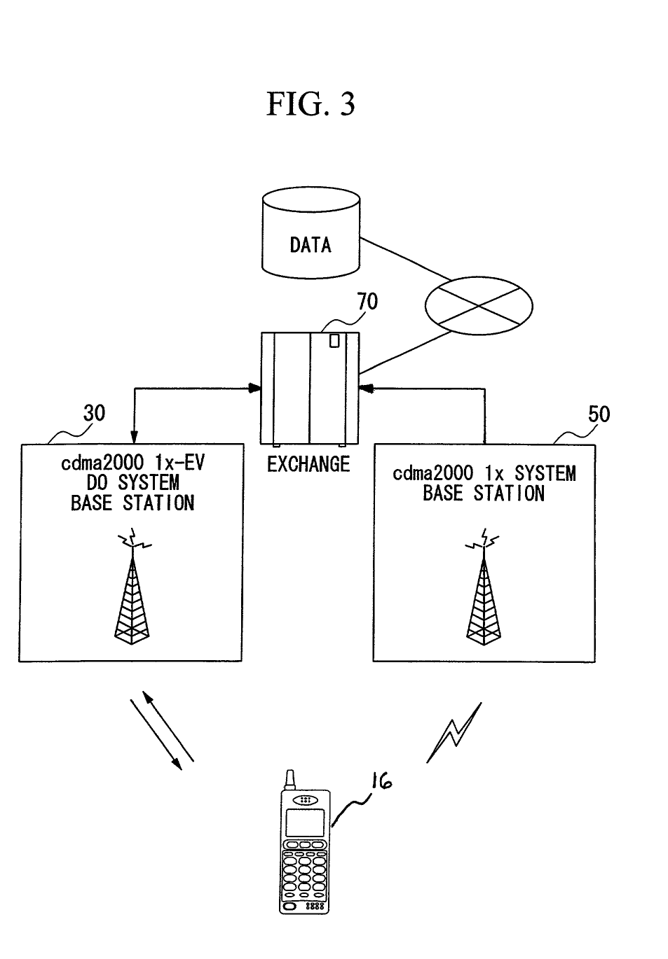

Then, CPU 7 provides signal processing circuit 5 with the download information regarding the download destination address and download data that are input via manual operation section 12. In signal processing circuit 5, the download information is subjected to digital processing; then, it is subjected to modulation based on the prescribed modulation method in transmission circuit 81. As shown in FIG. 3, the portable communication terminal may be capable of accessing two types of base stations, namely, base station 30 for the cdma2000 1x-EV DO system and base station 50 for the cdma2000 1x system. Prior to transmission, the portable communication terminal established the prescribed line for communicating with base station 30 that operates based on the cdma2000 1x-EV DO system. Hence, the portable communication terminal transmits the download information, which was processed and modulated, to base station 30 via the prescribed communication line.

Network Architecture of the Portable Communication Terminal

FIG. 3 shows an example of the network architecture that comprises the portable communication terminal 16, base stations, an exchange (or a local switch), and the like. Specifically, base station 30 presently establishes the communication line with the portable communication terminal in accordance with the cdma2000 1x-EV DO system. Base station 50 that operates based on the cdma2000 1x system is positioned within the prescribed service area allowing data communication with the portable communication terminal. Exchange (or local switch) 70 manages and controls base stations 30 and 50 based on the different wireless communication systems.

When base station 30 for the cdma2000 1x-EV DO system receives download information from the portable communication terminal, base station 30 sends the download information to exchange 70 that performs the prescribed control thereon.

Exchange 70 outputs a line connection request to the accessed destination (e.g., provider or server) on the basis of the download information transmitted thereto from base station 30. If the accessed destination responds to the line connection request, the prescribed communication line is established between the portable communication terminal and the accessed destination. Thus, it is possible to start downloading the desired data with respect to the portable communication terminal. That is, the downloaded data are transmitted to the portable communication terminal via exchange 70 and base station 30 respectively.

In the above, base station 30 produces a pilot signal that is multiplexed within the downloaded data and is sent to the portable communication terminal, wherein the pilot signal represents the radio field condition established between the portable communication terminal and base station 30. The pilot signal is an important signal for the determination of the speed of the data communication between the portable communication terminal and base station 30. Hence, the portable communication terminal predicts the ‘future’ data communication speed, which will be required a certain time later, on the basis of the pilot signal. Thus, the portable communication terminal makes a decision as to whether or not it can continue the data communication in a stable manner.

Specifically, base station 30 intermittently sends a pilot signal multiplexed with the downloaded data every 1/600 second. The multiplexed signals corresponding to the downloaded data multiplexing the pilot signal are received by antenna 1 of the portable communication terminal, wherein they are input to reception circuit 31 for the cdma2000 1x-EV DO system within multi-reception circuit 3, as shown in FIG. 1.

Reception circuit 31 demodulates the multiplexed signals with respect to the prescribed base bandwidth in reception in accordance with the prescribed demodulation method, which corresponds to the modulation method for use in the base station 30 in transmission of the multiplexed signals towards the portable communication terminal. The present embodiment employs any one of the three types of demodulation methods, that is, QPSK (Quaternary Phase-Shift Keying), 8PSK (Phase-Shift Keying), and 16 QAM (Quadrature Amplitude Modulation).

Reception circuit 31 demodulates the multiplexed signals to provide received data, which are forwarded to signal processing circuit 5.

Signal processing circuit 5 receives from multi-reception circuit 3 the received multiplexed signals that are received in spread spectrum, so that it performs inverse spread spectrum operations to isolate the pilot signal from the downloaded data. The downloaded data are decoded and are then supplied to CPU 7.

Signal processing circuit 5 calculates an Ec/Io value representing the pilot signal intensity against the overall receiving signal intensity, thus producing a CIR (i.e., carrier-to-interference ratio) in accordance with the following equation.

$$C I R = \frac{E c / I o}{1 - E c / I o}$$

Based on the calculated CIR, signal processing circuit 5 predicts a next value of CIR for the next reception slot timing (wherein one slot is approximately set to 1.66 milli-second, i.e., 1/600 second). With respect to the prediction method, it is possible to use the linear predictive method, for example.

The information for designating the number of slots by which signal processing circuit 5 should predict the CIR is contained in various control signals that the base station automatically sends to the portable communication terminal whose power switch is turned on.

When signal processing circuit 5 predicts the next value of CIR for the next reception slot timing, it performs processing to convert the predicted value of CIR to a DRC (or dynamically redefinable character) value representing a data communication speed. In this processing, signal processing circuit 5 merely refers to the prescribed conversion table, which is stored in RAM 11 in advance, to read the corresponding value in correspondence with the CIR value. That is, the DRC value represents the ‘predicted’ data communication speed that is read based on the predicted value of CIR and that can be used for the next reception slot timing. Hereinafter, the DRC value will be referred to as the predicted data communication speed.

When producing the predicted data communication speed by a series of processes described above, signal processing circuit 5 sends it to CPU 7.

In CPU 7, the predicted data communication speed given from signal processing circuit 5 is compared with the threshold that is stored in RAM 11 in advance in step SP2 shown in FIG. 2. If the predicted data communication speed is equal to or greater than the threshold, CPU 7 determines that the data communication should be continued based on the cdma2000 1x-EV DO system. That is, the decision result of step SP2 is ‘YES’, so that CPU 7 performs substantially no process thereafter.

If the predicted data communication speed is less than the threshold so that the decision result of step SP2 is ‘NO’, CPU 7 determines that the portable communication terminal is presently located in an inferior radio field condition where data communication may not be continued comfortably. Thus, CPU 7 performs a changeover process of the wireless communication system in step SP3, by which the cdma2000 1x-EV DO system is switched to the cdma2000 1x system.

First, as shown in FIG. 1, CPU 7 outputs information for instructing a changeover of the wireless communication system (hereinafter, simply referred to as a wireless communication system changeover instruction) to signal processing circuit 5. The wireless communication system changeover instruction is subjected to coding in signal processing circuit 5 and is then modulated by the prescribed modulation method in transmission circuit 81 for the cdma2000 1x-EV DO system within multi-transmission circuit 8. Thereafter, it is transmitted via antenna 1 of the portable communication terminal to the base station 30.

Base station 30 sends the wireless communication system changeover instruction from the portable communication terminal to exchange 70. Upon receipt of the instruction, exchange 70 extracts information of base station 50 for the cdma2000 1x system, which is provided relative to base station 30 for the cdma2000 1x-EV DO system. Then, exchange 70 sends the information of base station 50 to base station 30.

In the above, exchange 70 provides in advance a so-called base station table for storing various information data regarding the base stations that can be alternately used in response to changeovers between different wireless communication systems and that are located within the prescribed service area managed and controlled by itself. When exchange 70 receives a wireless communication system changeover instruction from the ‘first’ base station that belongs to the prescribed service area managed and controlled by itself, it refers to the base station table to extract information regarding the ‘second’ base station that is provided relative to the first base station regarding the wireless communication system changeover instruction. Then, exchange 70 sends the extracted information of the second base station to the first base station regarding the wireless communication system changeover instruction.

After sending the information of the second base station to the first base station, exchange 70 stops transmitting data to the first base station.

Specifically, when base station 30 receives the information of base station 50 from exchange 70, base station 30 transmits it to the portable communication terminal.

Thus, the information of base station 50 is received by the portable communication terminal via antenna 1 of FIG. 1, wherein it is demodulated by reception circuit 31 for the cdma2000 1x-EV DO system and is then subjected to digital processing by signal processing circuit 5. Thus, CPU 7 receives the information of base station 50. In order to establish a new communication line with base station 50, CPU 7 outputs changeover signals to multi-reception circuit 3 and multi-transmission circuit 8 respectively, so that it realizes a changeover from the cdma2000 1x-EV DO system to the cdma2000 1x system.

Specifically, multi-reception circuit 3 receives a changeover signal from CPU 7 to implement a changeover from reception circuit 31 to reception circuit 32. Similarly, multi-transmission circuit 8 receives a changeover signal from CPU 7 to implement a changeover from transmission circuit 81 to transmission circuit 82.

Then, CPU 7 performs various processes to establish the communication line with base station 50 for the cdma2000 1x system. As shown in FIG. 3, after establishing the communication line with the portable communication terminal, base station 50 sends to exchange 70 a message declaring that the communication line is completely established with the portable communication terminal. Therefore, exchange 70 recognizes the establishment of the communication line between the portable communication terminal and base station 50. Until then, exchange 70 temporarily stopped downloading data to the portable communication terminal via base station 30. After recognizing the establishment of the communication line, exchange 70 restarts downloading data to the portable communication terminal via ‘new’ base station 50.

As described above, a changeover between the different wireless communication systems is completed. Thus, it is possible to restart downloading data by way of base station 50 based on the cdma2000 1x system.

Even though the wireless communication system is changed over from the cdma2000 1x-EV DO system to the cdma2000 1x system, the portable communication terminal still and continuously receives pilot signals from base station 30 in prescribed time periods respectively. In the portable communication terminal, signal processing circuit 5 consecutively performs predictions with respect to the data communication speeds for the next slot timings, which are used in reception with base station 30 for the cdma2000 1x-EV DO system, in the prescribed time periods respectively. Therefore, CPU 7 consecutively performs comparisons between the threshold and the predicted data communication speeds that are predicted by signal processing circuit 5 in the prescribed time periods respectively. When the predicted data communication speed becomes equal to or greater than the threshold, CPU 7 performs a wireless communication system changeover process for implementing a changeover from the cdma2000 1x system to the cdma2000 1x-EV DO system.

A series of processes regarding the changeover of the wireless communication system are only required during the time period in which the portable communication terminal performs the data communication. Therefore, CPU 7 makes a decision as to whether or not the data communication is still continued in step SP4 after completing the comparison between the threshold and the predicted data communication speed in step SP2 shown in FIG. 2. That is, when the portable communication terminal completes the data communication, CPU 7 ends executing the series of processes regarding the changeover of the wireless communication system.

As described above, the portable communication terminal of the present embodiment is designed under the precondition that the data communication should be originally performed in accordance with the cdma2000 1x-EV DO system. However, at the location where the predicted data communication speed based on the cdma2000 1x-EV DO system becomes less than the threshold, the portable communication terminal determines that the user cannot enjoy the comfortable data communication environment. In such a location, the portable communication terminal automatically instructs a changeover from the cdma2000 1x-EV DO system to the cdma2000 1x system to secure the lower data communication speed and to wait for the restoration of the data communication speed that satisfies the cdma2000 1x-EV DO system.

As described above, the portable communication terminal of the present embodiment provides high-speed data communications based on the cdma2000 1x-EV DO system as long as the user can enjoy the comfortable data communication environment in accordance with the cdma2000 1x-EV DO system. Even though the portable communication terminal cannot provide the data communication speed that satisfies the cdma2000 1x-EV DO system, it automatically instructs a changeover from the cdma2000 1x-EV DO system to the cdma2000 1x system. Thus, it is possible to normally secure the minimal (or lowest) data communication speed, regardless of data communication environments.

Both the cdma2000 1x-EV DO system and the cdma2000 1x system use the same frequency bandwidth in data communications. For this reason, the portable communication terminal can easily recognize pilot signals transmitted from the base station for the cdma2000 1x-EV DO system even when it is performing data communication in accordance with the cdma2000 1x system. Therefore, the portable communication terminal is capable of predicting the future data communication speeds at any time in accordance with the aforementioned method based on the pilot signals.

That is, the portable communication terminal is capable of predicting the future data communication speeds with respect to the base station for the cdma2000 1 x-EV DO system, regardless of the wireless communication system that is presently used. Hence, the portable communication terminal can promptly perform various processes to switch to the cdma2000 1x-EV DO system when the predicted data communication speed becomes equal to or greater than the prescribed threshold.

The aforementioned network architecture shown in FIG. 3 shows that the portable communication terminal has capabilities of performing data communications with base station 30 for the cdma2000 1x-EV DO system and base station 50 for the cdma2000 1x system, both of which are managed and controlled by the same exchange 70. Further, as the user of the portable communication terminal moves from one place to another, handoff or hand-over may take place so that the base station that is communicating with the portable communication terminal is changed over from one to another even though the portable communication terminal performs data communication based on the same wireless communication system. That is, the network system normally enables the hand-over during the movement of the portable communication terminal.

Modifications of the First Embodiment

It is possible to provide various modifications with respect to the present embodiment of this invention, which will be described below.

The portable communication terminal of the present embodiment shown in FIG. 1 is designed such that both multi-reception circuit 3 and multi-transmission circuit 8 provide internal circuits for reception and transmission of signals based on the cdma2000 1x-EV DO system and cdma2000 1x system respectively. Of course, the wireless communication systems that can be applied to the present embodiment are not necessarily limited to them. Hence, the portable communication terminal of the present embodiment can be easily modified to employ reception circuits and transmission circuits based on other wireless communication systems. In addition, the portable communication terminal of the present embodiment can be modified to additionally provide the reception circuit and transmission circuit based on the other wireless communication system.

The base stations normally transmit pilot signals to the portable communication terminal in the prescribed time periods respectively, regardless of whether or not the portable communication terminal is presently performing data communication. Since the present embodiment is characterized by the automatic changeover between the different wireless communication systems during the data communication, the detailed description regarding controls performed in a non-data communication mode is omitted.

Technical Features and Effects of the First Embodiment

As described above, the first embodiment of this invention provides a variety of technical features and effects, which will be described below.

(1) The portable communication terminal of the first embodiment provides multiple transceivers that work in accordance with different wireless communication systems respectively, a data communication speed predictor for predicting future data communication speeds based on pilot signals transmitted thereto from the prescribed base station with respect to at least one wireless communication system, a wireless communication system selector for automatically selecting the optimal wireless communication system based on the predicted data communication speeds, a wireless communication system changeover instructor for instructing the base station, with which a communication line is presently established, to switch to the selected wireless communication system that differs from the presently used wireless communication system, and an automatic changeover for automatically changing over the transceiver to suit the selected wireless communication system in conjunction with the base station for the selected wireless communication system. Therefore, the portable communication terminal is capable of normally selecting the optimal wireless communication system in response to the predicted data communication speeds. Hence, it can proceed to the data communication in accordance with the optimal wireless communication system.

(2) The portable communication terminal of the present embodiment works under the precondition that the prescribed wireless communication system (e.g., the cdma2000 1x-EV DO system) is given a first priority in the data communication compared to the other wireless communication system (e.g., the cdma2000 1x system). However, at a certain location where the predicted data communication speed becomes less than the threshold with respect to the prescribed wireless communication system, the portable communication terminal determines that the user cannot enjoy a comfortable data communication environment, so that the portable communication terminal automatically switches to the other wireless communication system to secure the lower data communication speed and to wait for the restoration of the data communication speed. That is, the portable communication terminal normally works in accordance with the prescribed wireless communication system so that the user can enjoy the comfortable high-speed data communication unless the predicted data communication speeds are less than the threshold with respect to the prescribed wireless communication system. If the predicted data communication speed becomes less than the threshold, the portable communication terminal automatically switches to the other wireless communication system, so that it can secure the minimal data communication speed which may minimally satisfy the user's need in the data communication. As a result, the portable communication terminal is capable of normally providing the user with good data communication quality, regardless of the data communication environment.

(3) With respect to the prescribed wireless communication system, the portable communication terminal predicts downstream data communication speeds based on receiving conditions of signals from the base station, so that the base station is notified of the predicted downstream data communication speeds. Hence, the base station transmits data to the portable communication terminal at the predicted downstream data communication speed in accordance with the prescribed wireless communication system.

(4) The prescribed wireless communication system (i.e., the cdma2000 1x-EV DO system) is given a first priority in the data communication of the portable communication terminal, so that the user can normally enjoy the high-speed data communication. When the portable communication terminal cannot provide the required data communication speed based on the cdma2000 1x-EV DO system, it automatically switches to the other wireless communication system to secure the minimal data communication speed that may minimally satisfy the user's need in the data communication.

(5) The aforementioned automatic changeover of the portable communication terminal normally selects the transceiver to suit the prescribed wireless communication system in a non-data communication mode. In other words, even though the user suddenly starts data communication, the portable communication terminal has been already placed in a standby mode for activating the data communication based on the prescribed wireless communication system that is given a first priority. That is, in order to promptly start the data communication, the portable communication terminal does not necessarily change over its transceiver. Since the portable communication terminal does not need an initial changeover operation for initially changing over the transceiver to promptly start the data communication, it is possible to reduce the consumption of electricity in the portable communication terminal.

(6) An exchange (or a local switch) provides a base station table that stores in advance multiple information data regarding base stations, which can be alternatively used in response to changeovers between different wireless communication systems. The portable communication terminal issues a wireless communication system changeover instruction in order to realize a changeover of the wireless communication system from the prescribed one to the other. Upon receipt of such an instruction via the prescribed base station, the exchange reads from the base station table the information of the other base station, which is then sent to the prescribed base station, while stopping data transmission with the prescribed base station. On the other hand, the portable communication terminal establishes a communication line with the other base station, which in turn sends a message declaring the establishment of the communication line with the portable communication terminal. Upon receipt of such a message, the exchange restarts the data transmission, which is stopped for the prescribed base station, with respect to the other base station. Since the exchange provides the base station table for storing the information data regarding the base stations for the different wireless communication systems, it can promptly select the optimal base station in response to the wireless communication system changeover instruction issued by the portable communication terminal. Hence, it is possible to promptly perform a series of processes with regard to the changeover of the wireless communication system.

Second Embodiment

Next, a portable communication terminal of a second embodiment of the invention will be described with reference to FIG. 1. Compared to the foregoing first embodiment, the second embodiment additionally provides a timer 14 that is connected to CPU 7 to count the prescribed time period, which is set in advance.

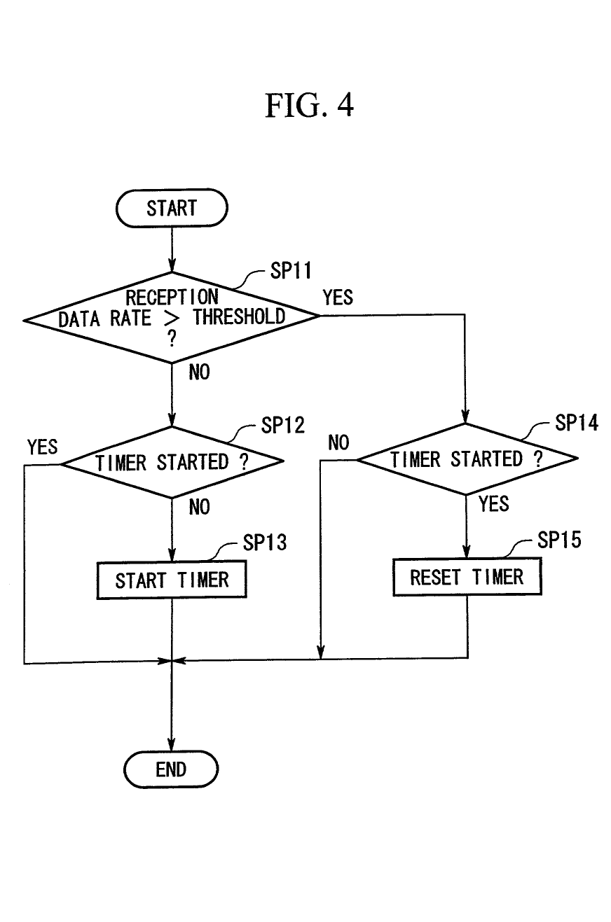

As described before in conjunction with FIG. 1, signal processing circuit 5 isolates the pilot signal from the download data, which are decoded and are then supplied to CPU 7. CPU 7 calculates reception data rate D1 for the reception of the download data. In other words, CPU 7 calculates it based on the amount of data that are received within the preset time period. Then, CPU 7 makes a decision, in response to the calculated reception data rate D1, as to whether or not the presently used wireless communication system should be changed to the other wireless communication system. That is, CPU 7 performs a wireless communication system changeover determination process, details of which will be described with reference to FIG. 4. CPU 7 repeatedly performs this process every prescribed timing.

In step SP11, CPU 7 makes a decision as to whether or not reception data rate D1 exceeds a prescribed threshold D_LMT that is stored in RAM 11 in advance. Reception data rate D1 is calculated based on the amount of data that the portable communication terminal has received in a first time period Td (ms). The amount of data received in the first time period Td (ms) may correspond to the amount of data that the portable communication terminal actually received from the base station. Alternatively, it may correspond to the amount of data that is accurately counted by the prescribed application. Of course, the present embodiment allows some margin of error that may be included in the amount of the received data.

Methods for Calculating the Reception Data Rate

It is possible to provide four types of methods for calculating reception data rate D1, which will be described below.

(a) CPU 7 measures an amount of received data that are output from signal processing circuit 5 in the first time period Td (ms), wherein it produces reception data rate D1 by dividing the measured amount of the received data by the first time period Td.

(b) CPU 7 measures an amount of received data in one frame, which is the minimal period in wireless communications. Then, it produces an ‘instantaneous’ reception data rate by multiplying the measured amount of the received data with the number ‘N’ of frames that are received in one second. By repeating the aforementioned calculations consecutively for one second, it is possible to produce ‘N’ instantaneous reception data rates in total. Then, reception data rate D1 is calculated by averaging the ‘N’ instantaneous reception data rates. Namely, the reception data rate D1 corresponds to an average of the instantaneous reception data rates. In this case, the first time period Td is set to one second.

(c) If the first time period Td (ms) is set longer than one second (where Td>1 sec.), the aforementioned calculations for averaging instantaneous reception data rates are repeatedly performed in the first time period Td. Thus, reception data rate D1 is produced in correspondence with an average of the instantaneous reception data rates that were consecutively calculated in the first time period Td.

(d) The aforementioned instantaneous reception data rate, which is calculated with respect to one frame, is directly assumed as reception data rate D1. In this case, the first time period Td (ms) is set to one frame.

In FIG. 4, when reception data rate D1 is less than the prescribed threshold D_LMT so that the decision result of step SP11 is ‘NO’, the flow proceeds to step SP12 wherein a decision is made as to whether or not timer 14 is started. If timer 14 is not started so that the decision result of step SP12 is ‘NO’, the flow proceeds to step SP13 to start timer 14. Thus, timer 14 starts counting a second time period T (ms), which is set in advance.

If timer 14 is started so that the decision result of step SP12 is ‘YES’, CPU 7 ends the process of FIG. 4.

When reception data rate D1 exceeds the prescribed threshold D LMT so that the decision result of step SP11 is ‘YES’, the flow proceeds to step SP14 wherein a decision is made as to whether or not timer 14 is started. If timer 14 is started so that the decision result of step SP14 is ‘YES’, the flow proceeds to step SP15 to reset timer 14. That is, timer 14 is unconditionally stopped if reception data rate D1 exceeds the prescribed threshold. Then, CPU 7 ends the process of FIG. 4.

If timer 14 is not started so that the decision result of step SP14 is ‘NO’, CPU 7 directly ends the process of FIG. 4.

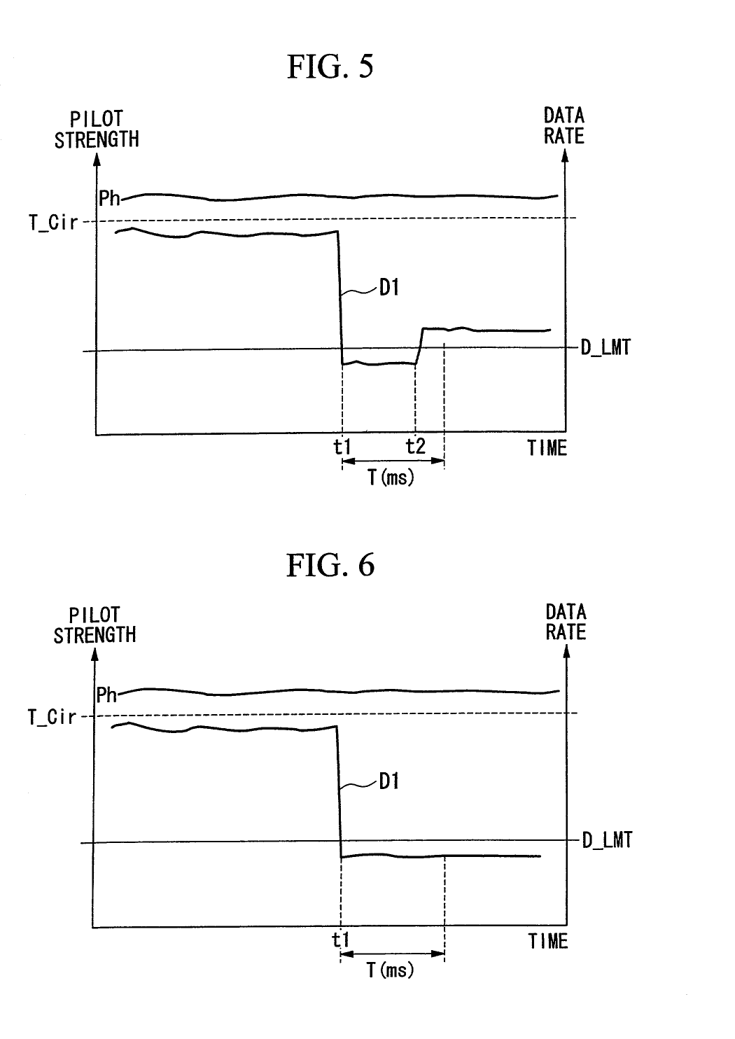

FIGS. 5 and 6 show variations of reception data rate D1 over time. In the graphs of these figures, the vertical axes represent the radio field condition (or pilot strength) and the reception data rate respectively, while the horizontal axis represents time. These graphs show that the pilot strength ‘Ph’ is normally above threshold T_Cir, which corresponds to the minimal value in securing the comfortable data communication. In addition, reception data rate D1 is initially above threshold D_LMT.

At time t1 when reception data rate D1 becomes lower than threshold D_LMT, CPU 7 activates timer 14 to start counting the second time period T (ms).

In the case of FIG. 5, reception data rate D1, which becomes lower than threshold D_LMT at time t1, is increased again to exceed threshold D_LMT at time t2 prior to a lapse of the second time period T (ms) that is counted from time t1. At time t2, CPU 7 resets timer 14 to stop counting the time.

In the case of FIG. 6, reception data rate D1, which becomes lower than threshold D_LMT at time t1, is continuously sustained to still remain lower than threshold D_LMT even though the second time period T counted by timer 14 completely elapses. In this case, timer 14 notifies CPU 7 of a time-up event in counting the second time period T. Specifically, timer 14 sends a time-up signal to CPU 7.

Upon receipt of the time-up signal, CPU 7 determines that the portable communication terminal could not perform the comfortable data communication. Therefore, CPU 7 instructs a changeover from the cdma2000 1x-Ev DO system to the cdma2000 1x system. Thus, the portable communication terminal performs the wireless communication system changeover process, which was described above in the first embodiment.

That is, the portable communication terminal performs a series of processes to proceed to a changeover of the wireless communication system. These processes are required only in the activating period of the data communication. Therefore, after completing the comparison between reception data rate D1 and threshold D_LMT (see step SP11 in FIG. 4), CPU 7 makes a decision once as to whether or not the data communication is still continued. After confirming an end of the data communication, CPU 7 ends the series of processes regarding the changeover of the wireless communication system. That is, CPU 7 ends the wireless communication system changeover determination process shown in FIG. 4.

Technical Features and Effects of the Second Embodiment

As described heretofore, the second embodiment of this invention provides various technical features and effects, which will be described below.

(1) The portable communication terminal automatically selects one of plural wireless communication systems installed therein in response to the amount of data that was received within the first time period, so that the portable communication terminal proceeds to data communication in accordance with the selected wireless communication system. In other words, the portable communication terminal is not designed to select the optimal wireless communication system in response to the radio field condition thereof, but is designed to select it in response to the amount of data that was received in the first time period. Therefore, even though the portable communication terminal receives data at an unexpectedly slow rate regardless of whether there is a good radio field condition, it is possible to easily increase the reception data rate by changing over the wireless communication system. Thus, it is possible to normally provide the user with the data communication service having a good quality in a stable manner.

(2) The cdma2000 1x-EV DO system is given a first priority because it can provide the user with a high data communication speed, so that the user can enjoy comfortable data communication in accordance with the cdma2000 1x-EV DO system. Even though amounts of data that are received in the first time period in accordance with the cdma2000 1x-EV DO system are continuously reduced for the second time period or more, the portable communication terminal automatically switches to the other wireless communication system. This guarantees the minimal data communication speed, which is minimally required for the comfortable data communication. As the other wireless communication system, the present embodiment employs the cdma2000 1x system and the like according to which channels are allocated independently to terminals. Therefore, it is possible to avoid occurrence of the situation where channels are allocated to other terminals prior to the portable communication terminal whose radio field condition is good. Thus, the portable communication terminal can continuously perform data communication while maintaining the optimal transmission rate therefore.

Lastly, this invention also provides programs implementing functions of the aforementioned portable communication terminal as well as computer-readable media storing these programs. As the computer-readable media, it is possible to provide a variety of digital storage media such as memory chips and cards. The foregoing embodiments of this invention describe cellular phones as examples of the portable communication terminal that operates in accordance with the CDMA system or PDC (Personal Digital Cellular) system. Of course, this invention is not necessarily limited to the cellular phones; hence, this invention is applicable to other types of portable terminals such as PDA (Personal Digital Assistant) devices that incorporate communicators or communication tools or that have connectibility with external communicators.

As this invention may be embodied in several forms without departing from the spirit or essential characteristics thereof, the present embodiments are therefore illustrative and not restrictive, since the scope of the invention is defined by the appended claims rather than by the description preceding them, and all variations that fall within metes and bounds of the claims, or equivalents of such metes and bounds are therefore intended to be embraced by the claims.

What is claimed is:

1. A portable communication terminal comprising:
a plurality of transceivers that work in accordance with a plurality of wireless communication systems respectively, wherein a prescribed wireless communication system is given a first priority to be used for reception and transmission of signals;
a data communication speed predictor for predicting a future data communication speed based on a pilot signal transmitted thereto from a prescribed base station for the prescribed wireless communication system within the plurality of wireless communication systems;
a wireless communication system selector for selecting an optimal wireless communication system from among the plurality of wireless communication systems in response to the future data communication speed that is predicted in advance by the data communication speed predictor with respect to the prescribed wireless communication system;
a wireless communication system changeover instructor for when the selected wireless communication system differs from the prescribed wireless communication system presently used in data communication via the prescribed base station, sending a wireless communication system changeover instruction to the prescribed base station to instruct a changeover from the prescribed wireless communication system to the selected wireless communication system; and
an automatic changeover for automatically changing over the transceiver to suit the selected wireless communication system in response to information regarding a base station for the selected wireless communication system, which is transmitted thereto via the prescribed base station.

2. A portable communication terminal according to claim 1, wherein when the future data communication speed that is predicted with respect to the prescribed wireless communication system becomes less than a threshold that is set in advance, the wireless communication system selector selects the wireless communication system other than the prescribed wireless communication system so that the data communication is performed using the transceiver for the other wireless communication system, whereas when the future data communication speed that is predicted with respect to the prescribed wireless communication system becomes equal to or greater than the threshold during the data communication that is performed in accordance with the other wireless communication system, the wireless communication system selector selects the prescribed wireless communication system so that the data communication is performed using the transceiver for the prescribed wireless communication system.

3. A portable communication terminal according to claim 2, wherein the data communication speed predictor predicts a downstream data communication speed in response to a receiving condition of signals from the prescribed base station with respect to the prescribed wireless communication system, so that the data communication is performed at the predicted downstream data communication speed, and said prescribed base station is notified of said speed.

4. A portable communication terminal according to claim 3, wherein the transceiver for the prescribed wireless communication system is initially set up in a non data communication mode.

5. A portable communication terminal according to claim 1, wherein the prescribed wireless communication system is cdma2000 1x-EV DO system, and the other wireless communication system is cdma2000 1x system.

6. A portable communication terminal comprising:
a multi-reception circuit for receiving signals in accordance with a first wireless communication system and a second wireless communication system respectively;
a multi-transmission circuit for transmitting signals in accordance with the first wireless communication system and the second wireless communication system respectively;
a signal processing circuit for performing prescribed signal processings on received signals and transmitting signals respectively; and
a data communication controller for controlling data communication in such a way that when a future data communication speed that is predicted in advance in response to a pilot signal transmitted thereto from a first base station for the first wireless communication system becomes less than a prescribed threshold, both the multi-reception circuit and the multi-transmission circuit are automatically controlled to suit the second wireless communication system using a second base station.

7. A portable communication terminal according to claim 6, wherein both the multi-reception circuit and the multi-transmission circuit are initially subjected to a prescribed setup to suit the first wireless communication system, and wherein when the future data communication speed that is predicted with respect to the first wireless communication system becomes less than the prescribed threshold, both the multi-reception circuit and the multi-transmission circuit are automatically changed over to suit the second wireless communication system, whereas when the future data communication speed is restored during the data communication based on the second wireless communication system, both the multi-reception circuit and the multi-transmission circuit are automatically changed over to suit the first wireless communication system.

8. A portable communication terminal according to claim 6, wherein the first wireless communication system is cdma2000 1x-EV DO system, and the second wireless communication system is cdma2000 1x system.

9. A wireless data communication network system comprising:
an exchange;
a plurality of base stations that are managed and controlled by the exchange with respect to a plurality of wireless communication systems respectively; and
a portable communication terminal having capabilities to perform data communications in accordance with the plurality of wireless communication systems respectively,
wherein the portable communication terminal is capable of changing over the wireless communication system thereof by sending a wireless communication system changeover instruction to one of the prescribed base stations with which a communication line is presently established, so that the exchange transmits information regarding other base station to the portable communication terminal via the prescribed base station in response to the wireless communication system changeover instruction.

10. A wireless data communication network system according to claim 9, wherein the exchange provides in advance a base station table that stores information data with regard to the plurality of base stations that can be alternatively used within a prescribed service area, so that the information regarding the other base station is read from the base station table in response to the wireless communication system changeover instruction.

11. A wireless data communication network system according to claim 9, wherein the portable communication terminal initially performs data communication in accordance with a prescribed wireless communication system using a prescribed base station, whereas when a future data communication speed that is predicted in response to a pilot signal transmitted thereto from the prescribed base station becomes less than a prescribed threshold, the portable communication terminal proceeds to data communication in accordance with other wireless communication system by issuing the wireless communication system changeover instruction, which is transmitted to the prescribed base station.

12. A wireless data communication network system according to claim 9, wherein in response to the wireless communication system changeover instruction, the exchange transmits the information regarding the other base station to the portable communication terminal via the prescribed base station while temporarily stopping the data communication in accordance with the prescribed wireless communication system, thereafter, upon receipt of a message that a new communication line is established between the portable communication terminal and the other base station, the exchange restarts the data communication with the portable communication terminal in accordance with the other wireless communication system via the other base station.

13. A wireless data communication network system according to claim 9, wherein the prescribed wireless communication system is cdma2000 1x-EV DO system, and the other wireless communication system is cdma2000 1x system.

14. A wireless communication device comprising:
a plurality of transceivers for allowing reception and transmission of signals in accordance with a plurality of wireless communication systems respectively;
a wireless communication system selector for automatically selecting an optimal wireless communication system from among the plurality of wireless communication systems in response to an amount of data that is received in a first time period;
a wireless communication system changeover instructor for instructing a prescribed base station to change over a prescribed wireless communication system presently used to the selected wireless communication system; and
an automatic changeover for automatically changing over the transceiver to suit the selected wireless communication system in response to information of the other base station.

15. A wireless communication device according to claim 14, wherein in accordance with the prescribed wireless communication system, a future downstream data communication speed is predicted and the prescribed base station is notified of said speed to allow data communication at the predicted future downstream data communication speed.

16. A wireless communication device according to claim 14, wherein when amounts of data that are received by the first time period each are consecutively reduced lower than a prescribed threshold for a second time period or more, the prescribed wireless communication system is automatically switched to the other wireless communication system.

17. A wireless communication device according to claim 14, wherein the prescribed wireless communication system is cdma2000 1x-EV DO system, and the other wireless communication system is cdma2000 1x system.

18. A wireless communication method for a wireless communication device comprising a plurality of transceivers allowing reception and transmission of signals in accordance with a plurality of wireless communication systems respectively, said wireless communication method comprising the steps of:
measuring an amount of data that are received in a first time period;
automatically selecting an optimal wireless communication system from among the plurality of wireless communication systems;
sending a wireless communication system changeover instruction to a prescribed base station to change over a prescribed wireless communication system presently used to the selected wireless communication system; and
automatically changing over the transceiver to suit the selected wireless communication system in response to information of the other base station.

19. A wireless communication method according to claim 18, wherein the prescribed wireless communication system is cdma2000 1x-EV DO system, and the selected wireless communication system is cdma2000 1x system.

20. A wireless communication system changeover method for a wireless communication device comprising a plurality of transceivers allowing reception and transmission of signals in accordance with a plurality of wireless communication systems respectively, said wireless communication system changeover method comprising the steps of:
measuring a reception data rate in a first time period, which is set in advance;
comparing the reception data rate with a prescribed threshold;
if the reception data rate is not greater than the prescribed threshold, counting a second time period; and
allowing a changeover from a prescribed wireless communication system presently used to another wireless communication system if the reception data rate is continuously reduced for the second time period or more, so that the wireless communication device automatically changes over the transceiver to suit the other wireless communication system.

21. A wireless communication system changeover method according to claim 20 further comprising the step of:
if the reception data rate is greater than the prescribed threshold, maintaining the prescribed wireless communication system presently used.

22. A wireless communication system changeover method according to claim 20, wherein the prescribed wireless communication system is cdma2000 1x-EV DO system, and the other wireless communication system is cdma2000 1x system.
